(19) United States
(12) Patent Application Publication
(10) Pub. No.: US 2020/0346712 A1
(43) Pub. Date: Nov. 5, 2020

(54) DRIVE SYSTEM

(71) Applicant: Ricky FUSILLO, Garden City Park, NY (US)

(72) Inventor: Ricky FUSILLO, Garden City Park, NY (US)

(21) Appl. No.: 16/402,797

(22) Filed: May 3, 2019

(51) Int. Cl. B62M 9/02; F16H 9/24; F16H 9/04

(52) U.S. Cl. CPC B62M 9/02; F16H 9/04; F16H 9/24

(57) ABSTRACT

There is provided herein a drive system comprising a driving component; a driven component; a torque load-reducing device located between an exit point of the driven component and an entry point of the driving component, which torque load-reducing device comprises at least two wheels wherein one wheel is offset from the other wheel in substantially the same plane; and, a continuous loop of torque load-bearing line connecting the driving component, driven component, and the torque load-reducing device.

### BACKGROUND

### 1. Field of the Invention

The present application is directed to a drive system which facilitates a reduction in the force necessary to operate another device, e.g., a machine or vehicle.

### 2. Background of the Art

Drive systems that transmit a torque from a driving axle to a driven axle are well known. A variety of gear arrangements have been used for transmitting torque through a drive system. These arrangements utilize a wide variety of devices to transfer rotary power from one location to another in the drive system. Conventional automobiles, bicycles and conveyer belts all usually depend upon rotating components such as gears, chains and derailleurs.

As can be appreciated from the foregoing, drive systems for various apparatus require a degree of force necessary to achieve a suitable torque to drive a driving component connected thereto. This demand presents a challenge for drive system designers to minimize size, weight, and effort needed for converting force input into a driving component into torque to drive the drive system.

Thus, there is a need for a drive system for various vehicles and machines such as bicycles, motorcycles and conveyer belts, which permits the system to reduce the force needed to provide the necessary torque to operate the drive system.

### SUMMARY

A drive system is provided herein, which drive system can be utilized, e.g., in a machine or vehicle, to reduce the necessary input force needed to operate the drive system.

There is provided herein a drive system, comprising:

a driving component;

a driven component;

a torque load-reducing device located between an exit point of the driven component and an entry point of the driving component, the torque load-reducing device comprising:
at least two wheels wherein one wheel is offset from the other wheel in substantially the same plane; and,

a continuous loop of torque load-bearing line connecting the driving component, the driven component and the torque load-reducing device.

There is also provided herein a process of operating the drive system.

### BRIEF DESCRIPTION OF THE DRAWINGS

Various embodiments are described below with reference to the drawings wherein:

FIG. 1 is a side view of a drive system according to the present disclosure;

FIGS. 2A-2E are different embodiments of the torque load-reducing device according to the present disclosure;

FIG. 3A is a frontal view of the torque load-reducing device depicting the fixed position of the wheels of the torque load-reducing device relative to one another in substantially the same plane along the vector “Z” and the fixed distance apart “X” depicted in FIG. 1, according to the present disclosure;

FIG. 3B is a top view of a chain according to the present disclosure;

FIG. 3C is a side view of a wheel of the torque load-reducing device which is a gear according to the present disclosure;

FIG. 4 is a side view of a portion of a bicycle containing the drive system according to the present disclosure;

FIG. 5 is a side view of a portion of a bicycle containing the drive system fixed in place using more than two different components according to the present disclosure; and,

FIG. 6 is a side view of a portion of a bicycle containing the drive system fixed in place using a single straight component.

FIG. 7 is a side view of a portion of a bicycle containing the drive system fixed on the chain stay of the bicycle and showing the direction of the movement of the chain in one embodiment through the drive system.

FIG. 8 is a top view of the drive system showing the movement of the chain in the embodiment shown in FIG. 7 originating from the back gear of the bicycle and exiting from the drive system in the direction of the pedal gear mechanism of the bicycle.

Like reference numerals indicate similar parts throughout the figures.

### DETAILED DESCRIPTION OF PREFERRED EMBODIMENT(S)

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

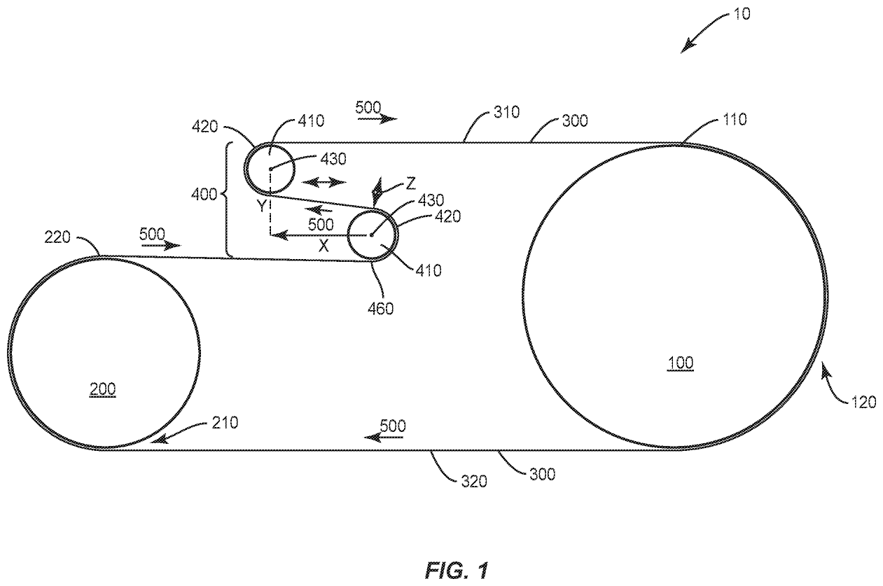

Referring to FIG. 1, there is provided a drive system 10. The drive system 10 contains at least a driving component 100, a driven component 200, a torque load-reducing device 400, and a continuous loop of torque load-bearing line 300. The torque load-bearing line 300 connects the driving component 100, driven component 200, and the torque load-reducing device 400.

The torque load-reducing device 400 comprises at least two wheels 410. One wheel 410 of the torque load-reducing device is offset from the other wheel 410 in the same plane. The term “offset” as used herein will be understood such that one wheel 410 is in a positionally different location from the at least one other wheel 410 in at least a Y-vector direction of the same plane.

In another embodiment, the term “offset” as used herein will be understood such that one wheel 410 is in a positionally different location from the other wheel 410 in at least one or two vector directions relative to the same plane selected from the group of an X-vector, Y-vector and Z-vector direction. Preferably, the offset of the two wheels 410 are a positional difference of one wheel 410 from another wheel 410 in the X-vector and Y-vector directions, and optionally, also of the Z-vector direction of the same plane. In a separate embodiment, the offset of at least two wheels 410 are a positional difference in the Y-vector direction only of the same plane, and optionally, also in the Z-vector direction of the same plane. In yet another embodiment, the offset can be a positional difference in the X-vector, and optionally also in the Z-vector.

The wheels 410 are in a fixed position relative to each other, and relative to the driving component 100 and the driven component 200 in the same plane as described above in the offset position(s) of the same plane. In one embodiment, the driving component 100 and the driven component 200 are in the same plane, and thus, are separated in a X-vector direction but not in a Z-vector direction.

The wheels 410 can be fixed relative to each other in any configuration that behooves a particular drive system 10, vehicle or machine 50 in which they are employed. The expression “the same plane” as used herein is understood to be from an exact fixed alignment of the wheels 410 in a single plane to about 3 inches apart in a Z-vector direction, preferably from an exact alignment to 14 inches apart, more preferably from an exact alignment to 8 inches apart, and most preferably in an exact alignment such that there is no difference in Z-vector direction.

Examples of such aligned fixed wheels 410 in the same plane is depicted in FIG. 3A. The aligned distance between the two wheels 410 being depicted in FIG. 3A by the Z-vector reference “Z”, as being “in the same plane”, which view is a view of the wheels 410 along the direction vector “Z” set out in FIG. 1 and as viewed from the frontal view of the drive system 10.

In one embodiment herein, a centerpoint 430 of one wheel 410 is offset from a centerpoint 430 of another wheel 410 in the drive system 10. The use of the term offset with regard to the centerpoints 430 is understood to be the same as described above for the offset of the wheels 410. The centerpoints 430 of the wheels 410 are described in FIGS. 1, 2a-2e and 4-6, when the drive system 10 is viewed from the side, such that one centerpoint 430 is higher in a Y-vector direction than the other centerpoint 430 in the same plane as is described above.

In one embodiment, the wheels 410 are equivalent in size and the centerpoint 430 of one wheel 410 is offset from the centerpoint 430 of another wheel 410 in Y-vector direction in the same plane in a range of from about 0 diameters to about 6 diameters, preferably from about 0 diameters to about 5 diameters. In the X-vector direction of the same plane the wheels can be separated of from about 1 diameters to about 18 diameters, preferably from about 2 diameters to about 12 diameters, when the wheels 410 are of the same size.

The fixed offset position of the wheels 410 is such that in one embodiment, one wheel 410 is located in its entirety, i.e., with no Y-vector overlap of one wheel 410 with the other wheel 410, above the other wheel in the Y-vector direction, but preferably, not in a position wherein the centerpoint 430 of one wheel 410 is directly in the same X-vector and Y-vector location of the centerpoint 430 of the other wheel 410. In one embodiment herein, the centerpoint 430 of one wheel 410 is at least 0 inches in the Y-vector direction above the other centerpoint 430 of the other wheel 410, preferably at least 1 inch, more preferably at least 6 inches.

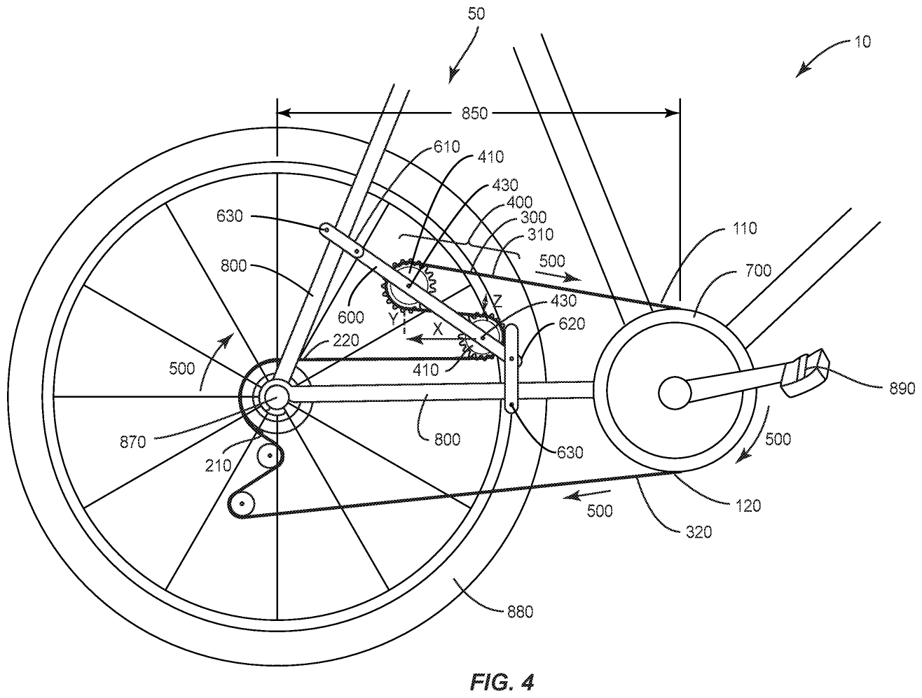

In one other embodiment herein, the centerpoints 430 of the respective wheels 410 are at least of a distance apart of the vector “Y” as shown in FIGS. 1, 3A and 4, and they do not overlap each other, but preferably have the above-noted diameter spacing. The wheels 410 when viewed from a side perspective of the drive system 10 such as in FIG. 1 can be separated horizontally from each other by an X-vector distance of from 1 diameter lengths of the wheels 410, when the diameters of the wheels 410 are equal, up to about 10 diameter lengths, preferably from 2 to 8 diameter lengths spacing. The vector X depicted in FIG. 1 is also described in other perspectives show in FIGS. 3A and 4.

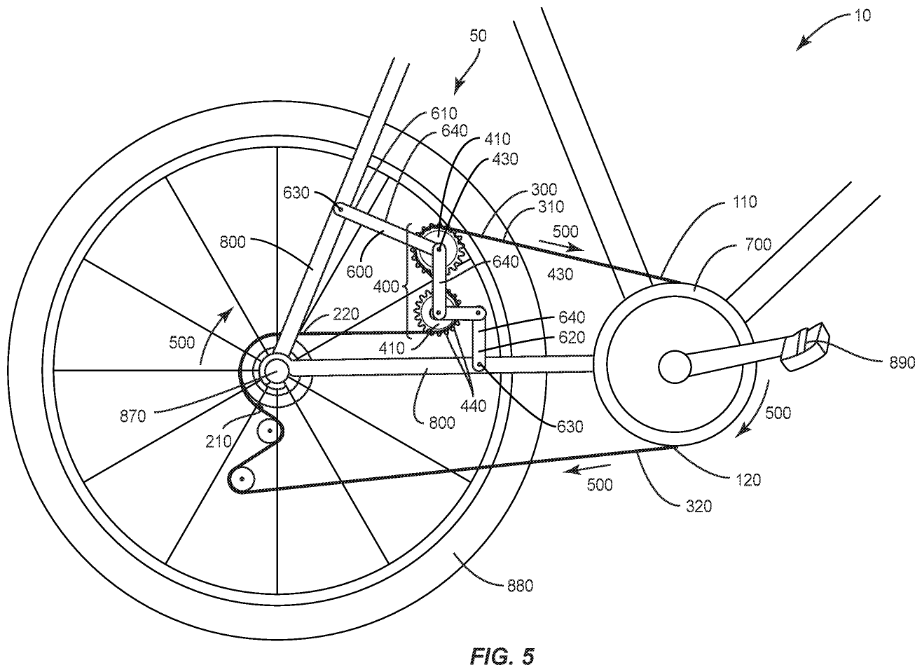

In one embodiment, as shown in FIGS. 1, and 4-6 one wheel 410 of the torque load-reducing device 400 is located closer to the driving component 100, and the other of the at least two wheels 410 is located closer to the driven component 200 in the same plane. Alternatively, one wheel 410 is directly above the other wheel 410 in the same plane as is shown in FIG. 5.

In one non-limiting embodiment herein, the wheels 410 can each be selected from the group consisting of a gear, pulley, sprocket, hub, rim, axis, shaft, knob, housing, arm, slot, blade, and the like. Preferably the at least two wheels 410 are both pulleys. In another embodiment, the two wheels 410 are pulleys of the same size. The two wheels 410 can be smaller in size than the driving component 100 and driven component 200.

In one embodiment herein, the wheels 410 can each be of the same diameter or can each have different diameters, i.e., each of the at least two wheels 410 can have the same diameter or be substantially different in size, for example, the wheels 410 can be at least 100% different in size areas as viewed from the side of the wheels 410. Preferably the wheels 410 have the same diameter. The wheels 410 can have any diameter suitable for the drive system 10, but preferably can be from 105% to about 150% different in size from each other, preferably from about 115% to about 150% different and most preferably from about 120% to 150% different in size.

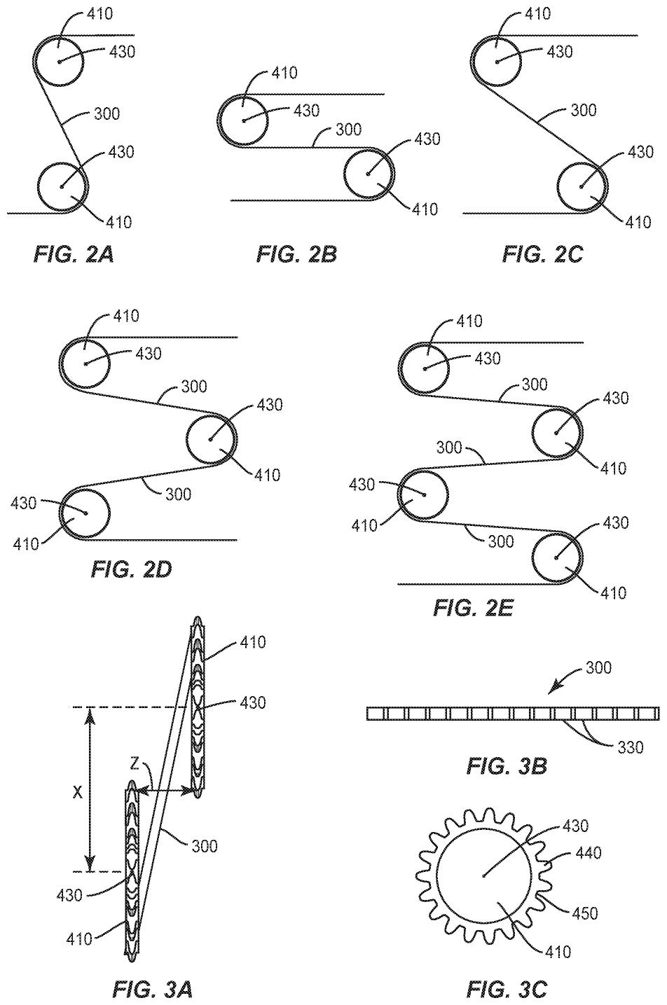

In one embodiment herein, the torque load-reducing device 400 can have more than 2 wheels 410, and can in some embodiments have 3 or 4, or more wheels 410 such as is depicted in FIGS. 2d and 2e. The wheel 410 can each be of a different size or of the same size. If the wheels are each the same size they each bear an equal portion of the force of the torque load-reducing device. Therefore, two wheels 410 reduce the force by ½ and three by ⅓. However, if the wheels 410 are of different size then each pulley will still bear the same force being assisted but the larger pulley(s) will rotate slower than the smaller pulleys which will rotate faster. The formula for determining pulley and belt ratio is the division of the drive pulley diameter by the load pulley diameter will be the pulley and belt ratio. A force ratio in a simple machine amplifies the input (effort) force to a larger output (load) force. The force ratio can be expressed as

Fᵣ=F/S

where
Fᵣ=force ratio-mechanical advantage
F=load force (N, lbf)
S=effort force (N, lbf).

The torque load-reducing device 400 is located along a load-bearing portion 310 of the continuous loop of torque load-bearing line 300 as shown in FIG. 1. The load-bearing portion 310 is in a directly opposite Y-vector location compared to a return 320 of the loop 300. The return 320 is located between the exit point 120 of the driving component 100 and the entry point 210 of the driven component 200. Preferably, the drive system 10 is such that it operates in a clockwise direction 500 from the driving component 100 to the driven component 200, and the torque load-reducing device 400 is located anywhere along, but preferably, approximately midway along, the load-bearing portion 310 of continuous loop of torque load-bearing line 300. The load-bearing portion 310 of the line 300 is between the exit point 220 of the driven component 200 and the entry point 110 of the driving component 100.

In one other non-limiting embodiment herein, the drive component 100 and/or the driven component 200 can also each be selected from the group consisting of a gear, pulley, sprocket, hub, rim, axis, shaft, knob, housing, arm, slot, blade, and the like. Preferably, the driving component 100 and the driven component 200 are both gears, and the continuous loop of torque load-bearing line 300 is a chain which is able to move in a clockwise direction.

In one embodiment the drive system 10 herein is a cycle drive system which has a driving component 100 which is a driving sprocket 100, and a driven sprocket 200 connected to the rear wheel of the cycle. The driving sprocket 100 is almost always larger than the driven one 200, and one shifts gears upwards, the torque-load bearing line 300 for example the chain 300 engages with progressively larger driving sprockets 100 in the front of the cycle while simultaneously shifting to smaller ones in the rear of the cycle. This increases the sprocket ratio, which makes it harder to pedal while increasing the rotational speed of the rear wheel. Motorcycle sprockets work in essentially the same way, except that it's the engine that has to work harder in higher gears, not the rider. The sprocket ratio is the number of teeth on the driving sprocket divided by the number of teeth on the driven sprocket.

It will be understood herein that the expression “torque load-bearing line” as used herein is the conventional understanding that a force applied in circular, axial-type direction is a torque, and that this torque is transmitted to the line by at least partially circumnavigating the circumference of an axis in a circular manner to transmit the circumferential force in a direction away from the axial rotation of the axis, and herein wherein such force is applied to the line 300 in a direction 500.

The continuous loop of torque load-bearing line 300 is a continuous line which wraps around at least a portion of the outer circumference, of both wheels 410. The contact of the outer circumference of both wheels 410 is an arc of contact 420. The wrapping around of the load bearing line 300 at the arc of contact 420 does so in a continuous S-shaped manner as is depicted in FIGS. 1, 2a-2e and 4-6. The term “continuous” as used with regard to line 300 is understood to be a single loop of line 300 extending through the components of the drive system 10, although multiple lines are envisioned although not illustrated.

In one non-limiting embodiment herein, the torque load-bearing line 300 as it moves in direction 500 is wrapped around an arc of contact 420 of the wheel 410 located further from an exit point 220 of the driven component 200 and then around an arc of contact 420 of the wheel 410 located closer to the exit point 220 of the driven component 200, and wherein the direction of motion 500 of the load-bearing line 300, substantially reverses direction therebetween. It will be understood that a substantially reversing in direction can comprise a direction of a line drawn tangentially to, but between the edges of the two wheels 410, (such as in the non-limiting embodiment of FIG. 1) such that a line 300 is then in a direction of movement 500, pointed in a direction opposite to the direction that the line 300 was moving prior to entering an entry point 460 of the lower wheel 410 in the torque load-reducing device 400.

The expression “at least a portion of the outer circumference” as used herein is understood to be a sufficient amount of the circumference to facilitate the engagement of the wheel 410 with the line 300 and will depend on the wheel 410 chosen and the line 300 chosen. Preferably such amount is from at least about 30% of the wheel 410 circumference to about 70% of the wheel circumference, and more preferably from about 40% to about 60% of the wheel 410 circumference. The amount of the wheel 410 circumference engaged by the line 300 can be different for each wheel 410 in the drive system or can be the same for each of the wheels 410 employed.

In another embodiment herein, the term “connecting” as it relates to the continuous loop of torque load-bearing line 300 connecting the driving component 100 and the driven component 200 comprises in part wrapping the loop of line 300 around at least part of the outer circumference of the driving component 100 and the driven component. These parts of the outer circumference can depend on the system 10, machine or vehicle 50, the size and placement of the wheels 410 and the driving component 100 and driven component 200, but can comprise in one embodiment the same amount of coverage described above for the arc of contact 420 with line 300 described herein for the wheels 410.

In one non-limiting embodiment herein, the line 300 does not cross itself and/or contact itself in the drive system 10. In one non-limiting embodiment herein, the continuous loop of torque load-bearing line 300 is selected from the non-limiting group consisting of a chain, belt, cable, cord, elastic, rope, string, and twine. In one embodiment the line 300 is a chain and the system 10 is employed in a bicycle 50.

Preferably, the line 300 can be selected from the group consisting of a chain, a rope, a belt and a cable. More preferably, the line 300 is a chain which contains links 330 as depicted in FIG. 3B which links 330 interact with the wheel 410 shown in FIG. 3C when wheel 410 is a gear through a conventional interaction with the teeth 440 and indentations 450 of the gear 410. In one non-limiting embodiment the line 300 is a bicycle chain. If the line 300 is a rope, belt or cable, then the wheels 410 can be pulleys which operate in the same manner as described herein for the general operation of the drive system 10.

The drive system 10 as described herein can be any one or more of a mechanical, electrical or manually-operable drive system 10. In one embodiment, the drive system 10 can be used in any vehicle or machine. Some non-limiting examples of vehicles 50 are automobiles, motorcycles, buses, trains, airplanes, helicopters, watercraft such as boats, barges, jet skis, and the like, bicycles, unicycles, tanks, ATVs, snowmobiles, baby carriages, golf carts, and the like. Preferably the vehicle 50 is a bicycle. Some types of machines 50 that can employ the drive system herein can be a chairlift, gondola, escalator, moving walkway, elevator, treadmill, conveyor system, Zamboni, shopping cart, wheelbarrow, wheelchair, lawnmower, and tractor.

With reference to FIGS. 4-7, in one embodiment herein, the drive system 10 is part of a bicycle 50, and the line 300 is a bicycle chain which during operation of the bicycle (e.g., during pedaling) the line 300 moves continuously in a clockwise direction 500 around a portion of at least the pedal gear mechanism 700 and a portion of the rear wheel gear mechanism axle 870 and wherein the torque load-reducing device 400 is located in a position along a top length 310 of the bicycle chain 300 such that the chain 300 passes through the torque load-reducing device 400 in a continuous manner, e.g., in direction 500, before engaging with the pedal gear mechanism 700 on the bicycle.

The cycle drive system 10 also contains a fixation component 600 which provides for the connection of the wheels 410 in their relative fixed position as described above as being above one another and spaced apart as noted for vectors X, Y and Z. The fixation component 600 has opposite ends 610 and 620, wherein each respective end has a connection component 630 capable of being attached to the frame 800 of a bicycle as depicted in FIGS. 4-7. The connection components 630 can be any conventional means for attaching the fixation component 600 to the frame 800, such as, but not limited to brackets, screws, bolts, and the like. The fixation component 600 can be made up of one or multiple separate plastic or metal (or the like) parts 640 and can be attached to the frame 800 in any suitable configuration desirable, such as, but not limited to, those depicted in FIGS. 4-7.

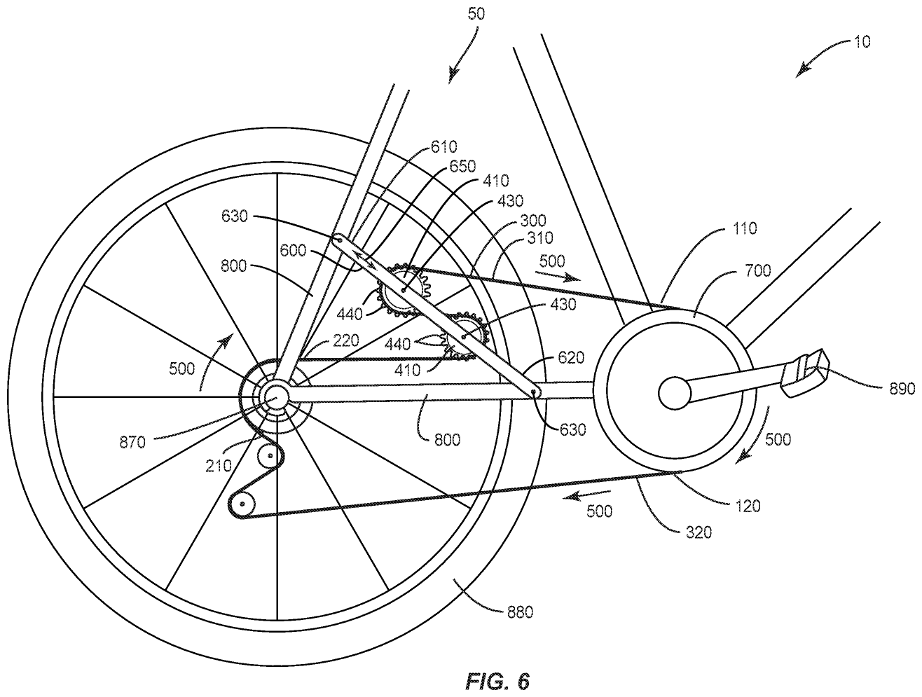

For example, the fixation component 600 can comprise at least two and preferably up to about 6, more preferably up to about 4, and most preferably 2 or 3 separate straight fixed length parts 640 as shown in FIG. 5. In another embodiment, such as that depicted in FIG. 6, the fixation component 600 can be a single straight adjustable length part 650 which can be adjusted as needed to suit any desired bicycle frame 800. While fixation component 600 is depicted in FIGS. 4-7 as being attached by connection components 630 to specific areas of the frame 800 of the bicycle, such locations can be altered to any desired location on the frame 800 of the bicycle and can be attached to different areas of the frame 800 or the same general area of frame 800.

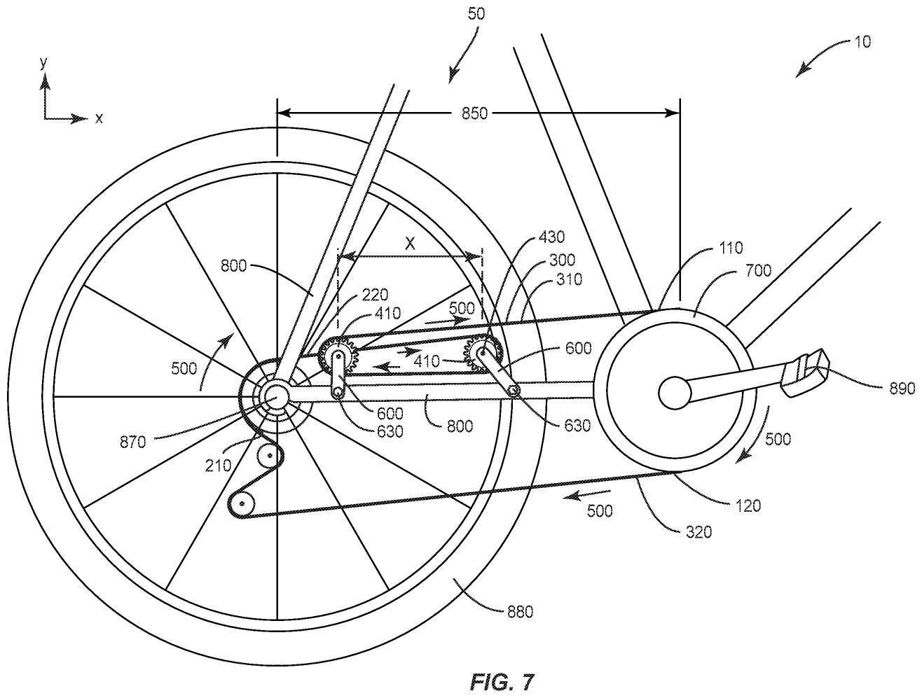

In one specific embodiment, the drive system 10 can be utilized on a bicycle 50, or any other device as described herein, as shown in FIG. 7. Specifically, as shown in FIG. 7, the drive system can have the two wheels 410 arranged an X-vector distance apart (offset), and, optionally, a Z-vector distance apart. The X-vector distance apart can be from 1 diameter of the wheel 410 apart to up to 18 diameters of the wheels apart, preferably from 2 to about 12 wheel diameter distances apart. In one non-limiting embodiment such an X-vector distance can be anywhere from wherein the wheels 410 edges are 1 to about 30 inches apart, preferably from 2 to about 20 inches apart and most preferably from 3 to about 12 inches apart. The Z vector distance can be preferably from 0 inches apart up to about 5 inches apart, preferably from 0.25 inches apart to 3 inches apart, and most preferably from about 0.5 inches apart to 2 inches apart.

The wheels 410 in FIG. 7 can be affixed to a part of the bicycle frame 800 such as the chain stay portion 800 of the bicycle 50, by employing any suitable means, but preferably a fixation component 600 such as is shown in FIG. 7. The fixation component 600 can be attached to the chain stay 800 by any suitable means such as a bolt, screw, rivet and the like which is depicted in 630 in FIG. 7. In addition, the fixation component 600 can be welded to any part of the bicycle frame, such as the chain stay, and/or built into the bicycle frame itself. While one of the fixation components 600 is shown in FIG. 7 to be angled from a vertical direction, such could also be employed in a completely vertical direction with no angle, and both fixation components 600 in FIG. 7 can be adjusted in any of the X, Y or Z-vector directions in a manner to facilitate the chain 300 moving most expeditiously through the drive system 10.

In FIG. 7 the direction of movement of the chain 300 is shown by reference numeral 500, wherein after passing through the rear wheel gear mechanism axle 870, the chain 300 moves first over the top of the front wheel 410 (front as relates to the position of both wheels 410) and then passes to the back wheel 410 from underneath and then over the top of the back wheel 410 and then moves in the direction 500 towards the pedal gear mechanism 700. The drive system 10 when utilized as a cycle drive system 10 can be utilized in any type of cycle, but preferably either a bicycle or motorcycle, but can also be used in training bicycles, unicycles, motor scooters, electric scooters, children's bicycles, and the like. Preferably the cycle drive system 10 is substantially centered between the pedal gear mechanism 700 and axle 870 of the rear tire 880 of a bicycle as shown by the positioning of reference numeral 850 in FIGS. 4 and 7. In one embodiment, as shown in FIG. 7 the drive system can be located closer to the rear wheel gear mechanism 870.

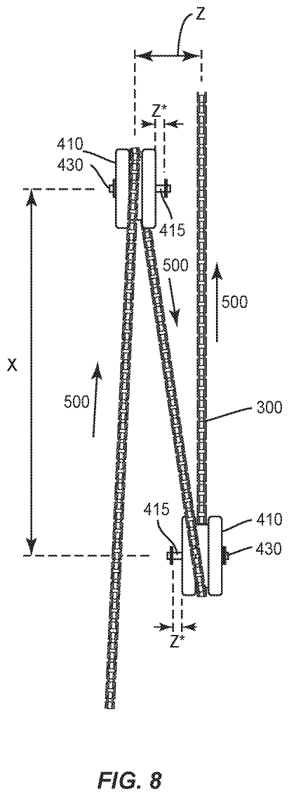

In FIG. 8 a top view of the drive system 10 shown in FIG. 7 is depicted to show the direction 500 of movement of the chain 300 as it moves in the manner described above with regard to FIG. 7. It can be seen that the offset in the Z-vector direction between the two wheels 410 can contain as part of that offset a certain amount of play Z* which occurs due to the axle pin 415 of both wheels 410 being longer than the Z-vector width of the wheel 410. This play Z* can be set to any distance suitable to facilitate the movement of the chain 300 through the drive system 10 most expeditiously while minimizing any undesirable chain catching or derailing thereof from the wheels 410 and or the rear gear mechanism 870 or the front wheel gear mechanism 700, as would be appreciated by those skilled in the art.

In one embodiment the cycle drive system 10 is only located along the top length 310 of line 300 as shown in FIGS. 1, and 4-7.

While not wishing to be bound by theory it is believed that the positioning of the torque load-reducing device 400 in the cycle drive system 10, e.g., on a cycle 50, as shown in the FIGS. 4-7, more preferably as shown in FIGS. 7 and 8, and as described herein, provides for the cycle 50, in operation, to produce a leverage on the line 300 which reduces the force necessary to pedal the cycle, especially when the torque load-reducing device 400 is placed in a position such that the line 300 passes through the torque load-reducing device 400 in a continuous manner in direction 500 before engaging with a pedal gear mechanism 700 of the cycle 50. Preferably, the torque load-reducing device 400 of the drive system 10 herein, preferably a cycle drive system, provides that when the system 100 is in operation, the torque load-reducing device 400 effects a reduction in the torque necessary to operate the driving component 100, as the line moves through the device 400. Preferably in a cycle drive system 10, this provides the cyclist with a torque force reduction of at least 25%, preferably at least 60% and more preferably at least 75% of the force needed to drive the driving component 100 of the cycle 50 compared to a cycle that is the absence of the cycle drive system 10.

Further still there is provided herein a process of operating the drive system 10, preferably when the drive system is used in a cycle, preferably a bicycle, comprising employing the cycle drive system 10 described herein and applying a force to the driving component 100, e.g., the gear mechanism by pedaling the pedals 890 in a manner sufficient to operate the system 10, e.g., when the force applied is sufficient to operate a gear mechanism in a bicycle as shown in FIGS. 4-7 and described herein. The employment of the cycle drive system 10 herein can comprise installing the components as described herein in their described general configuration on the bicycle 50 and pedaling the bicycle containing the drive system 10.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

Where this application has listed the steps of a method or procedure in a specific order, it may be possible, or even expedient in certain circumstances, to change the order in which some steps are performed, and it is intended that the particular steps of the method or procedure claim set forth herein below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. A drive system, comprising:
a driving component;
a driven component;
a torque load-reducing device located between an exit point of the driven component and an entry point of the driving component, the torque load-reducing device comprising:
at least two wheels, wherein one wheel is offset from the other wheel in the same plane, and wherein each of the at least two wheels provide an equal portion of a reduction of force to the drive system provided by the torque load-reducing device; and,
a continuous loop of torque load-bearing line connecting the driving component, the driven component and the torque load-reducing device.

2. The drive system of claim 1, wherein the at least two wheels of the torque load-reducing device are fixed in position relative to each other and relative to the driving and driven components.

3. The drive system of claim 1, wherein the offset of one of the at least two wheels in the torque load-reducing device is such that one of the at least two wheels is located in a positional difference of at least two of a set of X, Y or Z vectors of the same plane in relation to the other wheel.

4. The drive system of claim 1, wherein the at least two wheels are equivalent in size, and wherein each wheel has a centerpoint, and wherein the centerpoint of one wheel is offset from the centerpoint of a second wheel in the same plane in a distance of at least 0 diameters of the at least two wheels and up to 6 diameters of the at least two wheels.

5. The drive system of claim 1, wherein the torque load-reducing device comprises more than 2 wheels.

6. The drive system of claim 1, wherein the at least two wheels of the torque load-reducing device are selected from a group consisting of a pulley, gear, sprocket, hub, rim, axis, shaft, knob, housing, arm, slot, and a blade.

7. The drive system of claim 1, wherein the at least two wheels of the torque load-reducing device are pulleys.

8. The drive system of claim 1, wherein the continuous loop of torque load-bearing line is wrapped around an arc of contact of the wheel located further from the exit of the driven component and around an arc of contact of the wheel closer to the exit of the driven component and wherein a direction of motion of the continuous loop of torque load-bearing line substantially reverses direction therebetween.

9. The drive system of claim 1, wherein during the operation of the drive system, the torque load-reducing device effects a reduction in the torque necessary to operate the driving component as the continuous loop of torque-load bearing line moves through the torque load-reducing device.

10. The drive system of claim 1, wherein the drive system is a mechanical, electrical, or manually-operable system.

11. The drive system of claim 1 wherein the driving component and/or the driven component is selected from a group consisting of a gear, pulley, sprocket, hub, rim, axis, shaft, knob, housing, arm, slot, and a blade.

12. The drive system of claim 1, wherein the continuous loop of torque load-bearing line is selected from a group consisting of a chain, belt, cable, cord, elastic, rope, string, and twine.

13. The drive system of claim 1, wherein each of the driving component, driven component, and the at least two wheels of the torque load-reducing device are gears and the continuous loop of torque load-bearing line is a chain movable in a clockwise direction.

14. The drive system of claim 1, wherein the drive system operates in a clockwise direction from the driving component to the driven component, and the torque load-reducing device is located approximately mid-way between the exit point of the driven component and the entry point of the driving component.

15. The drive system of claim 1, wherein the drive system is a portion of a machine selected from a group consisting of a chairlift, gondola, escalator, moving walkway, elevator, treadmill, conveyor system, Zamboni, shopping cart, wheelbarrow, wheelchair, lawnmower, and tractor.

16. The drive system of claim 1, wherein the drive system is a portion of a vehicle which is selected from a group consisting of automobiles, motorcycles, buses, trains, airplanes, helicopters, watercraft, bicycles, unicycles, tanks, ATVs, snowmobiles, baby carriages, and golf carts.

17. The drive system of claim 16, wherein the vehicle is a bicycle.

18. A cycle drive system comprising:
a cycle driving gear;
a driven gear;
a torque load-reducing device located between an exit point of the driven gear and an entry point of the driving gear, which device comprises
at least two pulleys wherein one pulley is offset from the other pulley in substantially the same plane, and wherein each of the at least two pulleys provide an equal portion of a reduction of force to the drive system provided by the torque load-reducing device; and,
a continuous loop of torque load-bearing chain connecting the driving gear, driven gear, and the torque load-reducing device.

19. The cycle drive system of claim 18, which is a bicycle drive system.

20. A process of operating a drive system comprising:
providing a drive system which comprises
a driving component;
a driven component;
a torque load-reducing device located between an exit point of the driven component and an entry point of the driving component, which device comprises at least two wheels wherein one wheel is offset from the other wheel in substantially the same plane, and wherein each of the at least two wheels provide an equal portion of a reduction of force to the drive system provided by the torque load-reducing device; and,
a continuous loop of torque load-bearing line connecting the driving component, driven component and torque load-reducing device.

21. The drive system of claim 1, wherein the at least two wheels is two wheels each of the same size.

22. The drive system of claim 1, wherein the offset of one of the at least two wheels in the torque load-reducing device is such that one of the at least two wheels is located in a positional difference of at least the Z vector of the same plane in relation to the other wheel.

23. The drive system of claim 1, wherein the continuous loop of torque load-bearing line wraps around about 40% to about 70% of the wheel circumference of each of two wheels of the at least two wheels.
